(19) United States
(12) Patent Application Publication
(10) Pub. No.: US 2024/0088784 A1
(43) Pub. Date: Mar. 14, 2024

(54) DC-DC CONVERTER, VEHICLE INCLUDING CONVERTER, AND CONTROL METHOD THEREOF

(71) Applicants: HYUNDAI MOTOR COMPANY, Seoul (KR); KIA CORPORATION, Seoul (KR)

(72) Inventors: Jae Hun Jeong, Anyang-si (KR); Kyu Won Jeong, Hwaseong-si (KR); Beom Sik Kim, Gwangmyeong-si (KR); Mun Soo Chung, Uiwang-si (KR)

(21) Appl. No.: 18/120,245

(22) Filed: Mar. 10, 2023

(30) Foreign Application Priority Data
Sep. 14, 2022 (KR) 10-2022-0115922

(51) Int. Cl. H02M 3/07; H02J 7/00

(52) U.S. Cl. CPC H02M 3/07; H02J 7/00032; H02P 27/08

(57) ABSTRACT

A DC-DC converter may include a first capacitor connected to a first DC end, a second capacitor connected to a second DC end, a power conversion circuit connected between the first capacitor and the second capacitor and including at least one switching element, and a controller determining, when the second capacitor is charged as the battery is connected to the second DC end, whether the at least one switching element has failed based on a first voltage that is a voltage between opposite ends of the first capacitor and a second voltage that is a voltage between opposite ends of the second capacitor.

### CROSS REFERENCE TO RELATED APPLICATIONS

The present application claims priority to Korean Patent Application No. 10-2022-0115922, filed on Sep. 14, 2022, the entire contents of which is incorporated herein for all purposes by this reference.

### BACKGROUND

### Technical Field

The present description relates to a DC-DC converter, a vehicle including the converter, and a control method thereof. More particularly, the present description relates to a DC-DC converter, a vehicle including the converter, and a control method thereof capable of reducing additional damage due to a failure of the DC-DC converter that performs voltage transformation between opposite ends having voltages different from each other.

### Background

Recently, as an interest in the environment has increased, the development of an electrified vehicle having a motor as a driving source is being actively conducted. An example of such an electrified vehicle may be a fuel cell electric vehicle (FCEV).

The FCEV may refer to a vehicle driven by driving an electric motor with electric power generated through a chemical reaction between hydrogen and oxygen in a fuel cell. In order to stably supply power to the motor, a high-voltage battery may be provided between the fuel cell and a motor driving system including the electric motor and an inverter, and the voltage of the high-voltage battery has been continuously increased in order to increase efficiency and storage capacity.

Accordingly, when the voltage of the high-voltage battery is significantly higher than the voltage of the fuel cell, a DC-DC converter may be disposed between the fuel cell and the high-voltage battery to allow power exchange between the fuel cell and the high-voltage battery to take place. In this case, of opposite ends of the DC-DC converter, one end connected to the fuel cell having a relatively low-voltage becomes a low-voltage side LS, and an opposite end connected to the high-voltage battery having a relatively high-voltage becomes a high-voltage side HS.

In general, by considering the normal voltage range of the low-voltage side and high-voltage side of the DC-DC converter, the withstand voltage specification of the electrical equipment connected to each side is determined. However, when the DC-DC converter is implemented as a non-isolated type, a short circuit between the high-voltage side and the low-voltage side may occur due to a failure (for example, a short circuit breakage occurring in a power semiconductor such as an IGBT and the like). When the high-voltage on the high-voltage side, which is greater than a withstand voltage range considering a normal voltage range of the low-voltage side, is applied to electrical equipment connected to the low-voltage side due to a short circuit, occurrence of damage to the corresponding electrical equipment may take place.

In order to prevent low-voltage side damage due to a short circuit between the opposite ends of the DC-DC converter, the converter configuration may be implemented as an insulated type using a transformer, and the like, but compared to the non-isolated type, usually, the complexity is increased, and the efficiency is lowered. As another alternative, there is a method of increasing the withstand voltage of an electrical equipment connected to the low-voltage side of the DC-DC converter to a high-voltage side specification, but this also causes a significant increase in cost.

The foregoing is intended merely to aid in the understanding of the background of the present description and is not intended to mean that the present description falls within the purview of the related art that is already known to those skilled in the art.

### SUMMARY

Accordingly, the present description has been made keeping in mind the above problems occurring in the related art, and the present description is intended to provide a DC-DC converter and a vehicle including the converter and a control method thereof capable of reducing damage to electrical equipment on the low-voltage side when a failure that the low-voltage side and a high-voltage side are shorted occurs.

The technical problems to be achieved in the present description are not limited to the technical problems mentioned above, and other technical problems not mentioned will be clearly understood by those of ordinary skill in the art to which the present description belongs from the following description.

In order to achieve the above objective, according to one aspect of the present description, there may be provided a DC-DC converter including a first capacitor connected to a first DC end, a second capacitor connected to a second DC end, a power conversion circuit connected between the first capacitor and the second capacitor and including at least one switching element, and a controller determining, when the second capacitor is charged as a battery is connected to the second DC end, whether the at least one switching element has failed based on a first voltage that is a voltage between opposite ends of the first capacitor and a second voltage that is a voltage between opposite ends of the second capacitor.

For example, the power conversion circuit may include an inductor having one end connected to a positive (+) terminal of the first DC end; and a leg having one end connected to a positive (+) terminal of the second DC end and an opposite end connected to a negative (−) terminal of the second DC end, wherein the leg includes two switching elements connected in series with each other, and an opposite end of the inductor is connected to a connection node of the two switching elements.

For example, based on the first voltage and the second voltage, the controller may be configured to determine whether a top switching element having one end connected to the positive (+) terminal of the second DC end has failed in a short circuit, out of the two switching elements.

For example, the controller may be configured to determine whether the at least one switching element has failed after a preset time has elapsed after the battery was connected to the second DC end.

For example, the controller may be configured to receive a signal regarding whether the battery is connected to the second DC end from a battery management system that controls the battery.

For example, the controller may be configured to determine whether the at least one switching element has failed when the second capacitor is initially charged while the battery is connected to the second DC end through a pre-charge relay.

For example, the controller may be configured to determine that the at least one switching element has failed when the first voltage is no less than a value obtained by subtracting a preset margin voltage from the second voltage.

In addition, there may be provided a vehicle according to the present description, the vehicle including a DC-DC converter having a first DC end and a second DC end, a high-voltage battery selectively connected to the second DC end through a plurality of switches, and a controller configured to manage the high-voltage battery and control states of the plurality of switches, wherein the DC-DC converter includes a first capacitor connected to a first DC end, a second capacitor connected to a second DC end, and a power conversion circuit connected between the first capacitor and the second capacitor and including at least one switching element, and the controller is configured, when the second capacitor is charged as the battery is connected to the second DC end, to control the states of the plurality of switches based on a first voltage that is a voltage between opposite ends of the first capacitor and a second voltage that is a voltage between opposite ends of the second capacitor.

For example, the power conversion circuit may include an inductor having one end connected to a positive (+) terminal of the first DC end, and a leg having one end connected to a positive (+) terminal of the second DC end and an opposite end connected to a negative (−) terminal of the second DC end, wherein the leg includes two switching elements connected in series with each other, and an opposite end of the inductor is connected to a connection node of the two switching elements.

The controller may be configured to compare the first voltage with the second voltage after a preset time has elapsed after the high-voltage battery was connected to the second DC end.

For example, the controller may be configured to control the states of the plurality of switches such that the high-voltage battery is disconnected from the second DC terminal when the first voltage is no less than a value obtained by subtracting a preset margin voltage from the second voltage.

For example, the plurality of switches may include a first relay connected to one end of the battery, a second relay connected to an opposite end of the battery, and a third relay connected in parallel with the first relay to one end of the battery and connected in series with a pre-charge resistor.

For example, the controller may be configured to control the third relay to be in an ON state and the second relay to be in an ON state, thereby comparing the first voltage and the second voltage after the preset time has elapsed from the time when the initial charging of the second capacitor started.

For example, the controller may be configured to control the third relay and the second relay to be in the ON state and then compare the first voltage and the second voltage until controlling the first relay to be in the ON state according to satisfaction of a preset condition.

For example, the controller may be configured to obtain information on the first voltage from the DC-DC converter or electrical equipment connected to the first DC end.

For example, the vehicle may further include a fuel cell connected to the first DC end.

As described above, according to the vehicle above, a connection state between a high-voltage battery and a high-voltage side of a DC-DC converter is controlled based on a capacitor voltage of a low-voltage side of the DC-DC converter measured in an initial charging section of a capacitor of the high-voltage side, whereby electrical equipment connected to the low-voltage side can be protected.

In particular, the electrical equipment connected to the low-voltage side can be protected without increasing the withstand voltage of the electrical equipment connected to the low-voltage side or configuring the DC-DC converter as an insulated type.

The effects obtainable in the present description are not limited to the above-mentioned effects, and other effects not mentioned will be clearly understood by those of ordinary skill in the art from the following description.

### BRIEF DESCRIPTION OF THE FIGURES

The above and other objectives, features, and other advantages of the present description will be more clearly understood from the following detailed description when taken in conjunction with the accompanying drawings, in which:

FIG. 1 illustrates an example of the configuration of a power electronic system of a fuel cell electric vehicle according to an embodiment of the present description;

FIG. 2 illustrates an example of the configuration of a control system of the fuel cell electric vehicle according to the embodiment of the present description;

FIG. 3 illustrates an example of an operation process of a fuel cell controller and a DC-DC converter according to the embodiment of the present description;

FIG. 4 is a circuit diagram illustrating a power conversion principle and a failure situation of a DC-DC converter according to an exemplary embodiment;

FIG. 5 shows graphs illustrating a form of performing fault diagnosis of the DC-DC converter in an initial charging procedure according to the embodiment of the present description; and

FIG. 6 is a flowchart illustrating an example of a control process of a fuel cell electric vehicle according to the embodiment of the present description.

### DETAILED DESCRIPTION

Hereinbelow, exemplary embodiments of the present description will be described in detail with reference to the accompanying drawings. Regardless of the reference numerals, the same or like components are assigned the same reference numerals, and overlapping descriptions thereof will be omitted. Suffixes “module” and “part” for components used in the following description are given or mixed in consideration of only the ease of writing the specification and do not have distinct meanings or roles by themselves. In addition, in describing the embodiments disclosed in the present specification, when it is determined that detailed descriptions of related known technologies may obfuscate the gist of the embodiments disclosed in the present specification, the detailed description thereof will be omitted. In addition, the accompanying drawings are only for easy understanding of the embodiments disclosed in this specification, do not limit the technical idea disclosed herein, and should be understood to include all changes, equivalents, or substitutes included in the spirit and scope of the present description.

Terms including an ordinal number, such as first, second, and the like, may be used to describe various components, but the components are not limited by the terms. The above terms are used only for the purpose of distinguishing one component from another.

When a component is referred to as being “connected” or “coupled” to another component, it may be directly connected or coupled to another component, but it should be understood that other components may exist in the middle. On the other hand, when a component is referred to as being “directly connected” or “directly connected” to another component, it should be understood that there are no other components in the middle.

A singular expression includes a plural expression unless the context clearly dictates otherwise.

In the present specification, terms such as “comprises” or “have” are intended to designate that the features, numbers, steps, operations, components, parts, or combinations thereof described in the specification exist and should be understood that it does not preclude the possibility of addition or existence of one or more other features, numbers, steps, operations, components, parts, or combinations thereof.

In addition, a unit or a control unit included in the names of a motor controller (MCU), a hybrid controller (HCU), and the like is only a term widely used in the naming of a control unit that controls a specific vehicle function but does not mean a generic function unit. For example, each controller may include a communication device that communicates with other controllers or sensors to control a function in charge, a memory that stores a command of an operating system or logic, input/output information, and the like, and at least one processor that performs judgment, operation, decision, and the like necessary for controlling the function in charge.

The following embodiments will be described on the assumption that they are applied to a hydrogen fuel cell vehicle, but it is obvious to those skilled in the art that this is for convenience of description and may also be applied to a vehicle equipped with two batteries having different normal voltage ranges in addition to the hydrogen fuel cell vehicle.

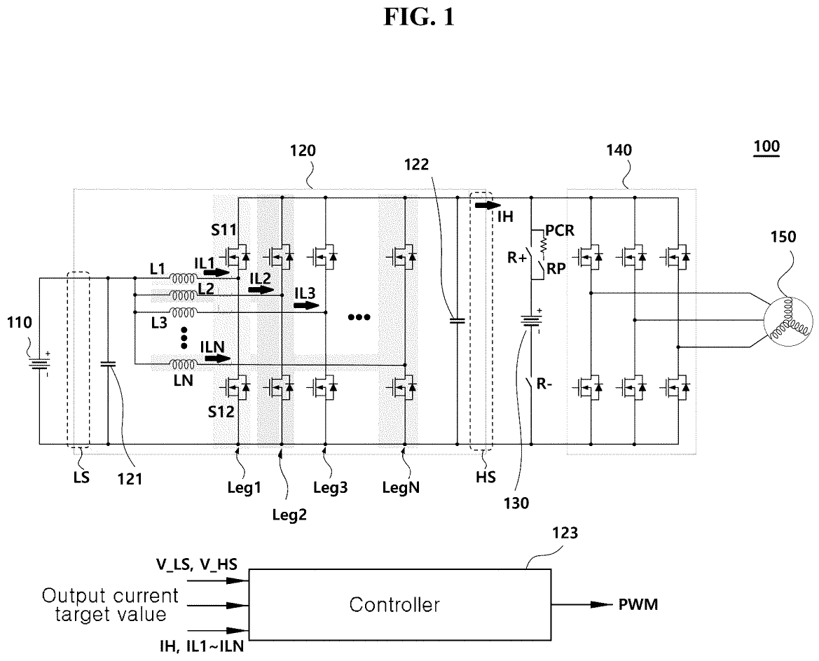

FIG. 1 illustrates an example of the configuration of a power electronic system of a fuel cell electric vehicle according to an embodiment of the present description.

With reference to FIG. 1, the fuel cell vehicle 100 according to an embodiment may include a fuel cell 110, a fuel cell DC-DC converter (FDC) 120 to one end of which the fuel cell 110 is connected, a high-voltage battery 130 connected to an opposite end of the FDC 120, an inverter 140 having a DC end connected to the opposite end of the FDC 120, and a motor 150 connected to an AC end of the inverter 140.

The fuel cell 110 may output power through a chemical reaction between hydrogen and oxygen. For example, the fuel cell 110 may have a form of a polymer electrolyte membrane fuel cell (PEMFC) (also known as a proton exchange membrane fuel cell), but this is exemplary and is not necessarily limited thereto.

The FDC 120 is provided with two DC ends, that is, one end electrically connected to the fuel cell 110 and an opposite end electrically connected to the high-voltage battery 130 and may transform a voltage of power input to the one end so as to correspond to a voltage of the opposite end, thereby performing a function of outputting the same to the opposite end. To this end, the FDC 120 may include a first capacitor 121 for stably maintaining the voltage at the one end, a second capacitor 122 for stably maintaining the voltage at the opposite end, a plurality of inductor-leg pairs forming a boost converter topology for power conversion, and a converter controller 123.

Here, assuming that the normal voltage range of the fuel cell 110 is relatively lower than the normal voltage range of the high-voltage battery 130, one end may be referred to as a low-voltage side LS and the opposite end may be referred to as a high-voltage side HS. The first capacitor 121 is connected between a negative (−) terminal and a positive (+) terminal of the low-voltage side LS, and the second capacitor 122 is connected between a negative (−) terminal and a positive (+) terminal of the high-voltage side HS. Here, the first capacitor 121 may be referred to as a “low-voltage side capacitor”, and the second capacitor 122 may be referred to as a “high-voltage side capacitor”.

In addition, a plurality of N inductor-leg pairs may be connected in parallel between the low-voltage side capacitor 121 and the high-voltage side capacitor 122. In more detail, one end of each of the N inductors L1, L2, L3, . . . , and LN is connected to the positive (+) terminal of the low-voltage side LS, and an opposite end of each of the N inductors L1, L2, L3, . . . , and LN is connected to the corresponding one leg of the plurality of legs Leg1, Leg2, Leg3, . . . , and LegN, thereby forming an inductor-leg pair.

Each of the legs Leg1, Leg2, Leg3, . . . , and LegN includes two switching elements connected in series to each other between the opposite terminals of the high-voltage side capacitor 122, and a connection node of the two switching elements may be connected to an opposite end of the inductor constituting the inductor-leg pair. As an example, the first leg Leg1 includes a first switching element S11 and a second switching element S12 connected in series to each other between the opposite terminals of the high-voltage side capacitor 122, and a connection node of the two switching elements S11 and S12 may be connected to the opposite end of the first inductor L1, thereby forming a first inductor-leg pair L1-Leg1. The first switching element S11 may be referred to as a “top switching element”, and the second switching element S12 may also be referred to as a “bottom switching element”.

Each switching element may be implemented as a power semiconductor device capable of high-power and high-speed switching, for example, an insulated gate bipolar transistor (IGBT), but is not necessarily limited thereto.

In addition, the converter controller 123 may control a state of each of the switching elements constituting each of the legs Leg1, Leg2, Leg3, . . . , and LegN through pulse width modulation (PWM) based on each of low-voltage side currents IL1, IL2, IL3, . . . , and ILN, a high-voltage side current IH, a voltage V_LS between opposite terminals of the low-voltage side capacitor 121, a voltage V_HS between opposite terminals of the high-voltage side capacitor 122, and an output current target value. To this end, the FDC 120 may further include a current sensor (not shown) and a voltage sensor (not shown) for measuring each current and voltage. Meanwhile, the output current target value may be information transmitted from a fuel cell control unit (FCU), which will be described later.

The high-voltage battery 130 may be connected between the positive (+) terminal and the negative (−) terminal of the high-voltage side HS through a plurality of switches, for example, a plurality of relays R+, R−, and RP. In more detail, the negative (−) electrode of the high-voltage battery 130 may be selectively connected to the negative (−) terminal of the high-voltage side HS through a negative electrode relay R−, and the positive (+) electrode of the high-voltage battery 130 may be selectively connected to the positive (+) terminal of the high-voltage side (HS) through a positive electrode relay R+ or a pre-charge relay RP. The pre-charge relay RP is connected in series with a pre-charge resistor PCR. When the negative electrode relay R− and the positive electrode relay R+ are turned on together, a large inrush current is instantaneously generated for initial charging of the high-voltage side capacitor 122, which may cause damage to the relay and the capacitor. Therefore, when the pre-charge relay RP is first turned on instead of the positive electrode relay R+ and the negative electrode relay R− is turned on, the inrush current may be reduced by the pre-charge resistor PCR connected in series to the pre-charge relay RP, thereby preventing damage to the relay and the capacitor. When the high-voltage side capacitor 122 is charged to no less than a predetermined voltage, the positive electrode relay R+ may be turned on and the pre-charge relay RP may be turned off. Depending on the implementation, each of the relays R+, R−, and RP may even be replaced with another type of switch, for example, a power semiconductor or the like.

The inverter 140 may convert the DC power of the high-voltage battery 130 into polyphase AC power, thereby driving the motor 150, or convert the AC power generated by the motor 150 into DC power, thereby transmitting the same to the high-voltage battery 130. To this end, the inverter 140 may have a plurality of legs, each of which corresponds to each of the polyphase. Since it is apparent to those skilled in the art that the polyphase motor and the inverter for driving the same may be implemented in various configurations, a further detailed description thereof will be omitted.

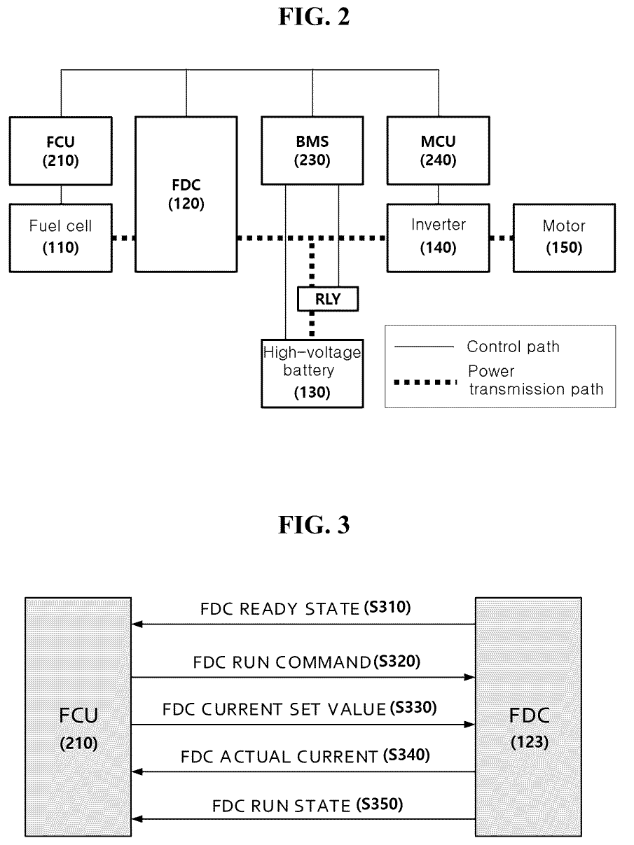

Based on the configuration of the power electronic system described above with reference to FIG. 1, a control system of the fuel cell vehicle will be described hereinbelow with reference to FIG. 2.

FIG. 2 illustrates a control system of the fuel cell electric vehicle according to the embodiment of the present description together with a power electronic system. In FIG. 2, a solid line connecting each component indicates a control signal transmission path, and a dotted line indicates a power transmission path, respectively. In addition, in the description of FIG. 2, since the power transmission path is the same as that described with reference to FIG. 1, an overlapping description will be omitted.

With reference to FIG. 2, the fuel cell 110 may be controlled by the fuel cell controller FCU 210, and the FDC 120 may be controlled by the converter controller 123. In addition, a battery management system (BMS) 230 may control an ON/OFF state of each of the relays (RLY) R+, R−, and RP and manage a state of the high-voltage battery 130.

In addition, the motor controller unit (MCU) 240 may control a gate drive unit (not shown) with a control signal in a form of pulse width modulation (PWM) based on a motor angle of the motor 150, a phase voltage, a phase current, required torque, and the like, and the gate drive unit may control the inverter 140 configured to drive the motor 150 according to the gate drive unit.

Each of the control entities 123, 210, 230, and 240 may exchange information or commands required for control through communication according to a predetermined vehicle communication protocol, for example, CAN (Controller Area Network) communication.

Next, an operation of the converter controller 123 of the FDC 120 through communication with the fuel cell controller 210 will be described with reference to FIG. 3.

FIG. 3 illustrates an example of an operation process of a fuel cell controller and a DC-DC converter according to the embodiment of the present description.

With reference to FIG. 3, the converter controller 123 is configured to transmit a message (FDC READY STATE) including a ready state (READY ON/OFF) of the FDC 120 to the fuel cell controller 210 in S310. When the FDC 120 is in an operation-ready state, the fuel cell controller 210 is configured to transmit an operation start request message (FDC RUN COMMAND) to the converter controller 123 in S320. At this time, an output current target value (FDC CURRENT SET VALUE) may also be transmitted in S330. Accordingly, the converter controller 123 is configured to drive the FDC 120 to satisfy the output current target value and, as a result, transmit the current value (FDC ACTUAL CURRENT) actually output from the FDC 120 to the fuel cell controller 210 in S340. In addition, the converter controller 123 may transmit a message (FDC RUN STATE) including an operation state (RUN ON/OFF) of the FDC 120 to the fuel cell controller 210 in S350.

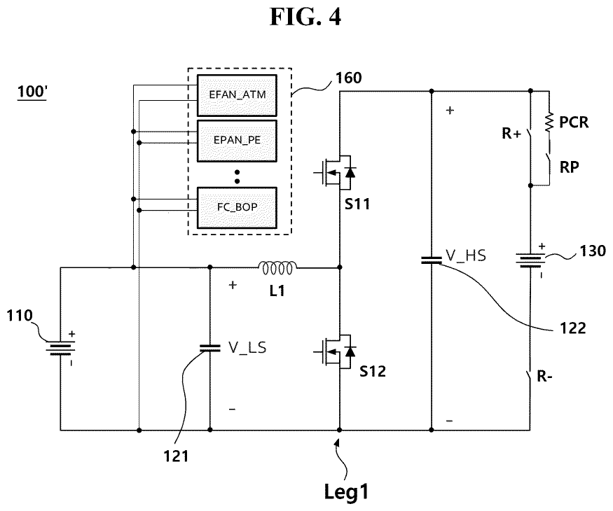

Based on the configuration of the fuel cell electric vehicle described so far, a voltage transformation operation and a short-circuit failure of the FDC 120 will be described below with reference to FIG. 4.

FIG. 4 is a circuit diagram illustrating a power conversion principle and a failure situation of a DC-DC converter according to an exemplary embodiment.

In FIG. 4, a configuration 100′ of a power electronic system of the fuel cell electric vehicle is illustrated, which is simplified compared with FIG. 1, but to which the electrical equipment 160 connected to the low-voltage side is added.

In more detail, in FIG. 4, only the first inductor-leg pair L1-Leg1 among the plurality of inductor-leg pairs is shown, and the inverter 140 and the motor 150 are omitted.

With reference to FIG. 4, when the high-voltage battery 130 is charged with the power of the fuel cell 110 while a normal voltage range of the fuel cell 110 is lower than a normal voltage range of the high-voltage battery 130, the FDC 120 is configured to boost the input voltage of the low-voltage side and output the same to the high-voltage side based on the boost converter topology. To this end, when the first switching element S11 is first turned off and the second switching element S12 is turned on, the current becomes to charge the first inductor L1 (that is, increasing the voltage applied to the first inductor) while flowing through the first inductor L1 to the second switching element S12. Thereafter, when the second switching element S12 is turned off, the current flows through the first inductor L 1 to the antiparallel diode (body diode) of the first switching element S11, and the voltage applied to the first inductor L1 is added to the low-voltage side voltage V_LS, that is, boosted. After all, when switching control for charging and discharging inductors is applied to a plurality of inductor-leg pairs at different timings, it is possible to supply continuously boosted power from the low-voltage side to the high-voltage side. The FDC 120 may also implement a buck converter topology according to a switching control, and in this case, the power of the high-voltage battery 130 may be output to the low-voltage side by stepping down, so that it may operate as a bidirectional converter. Accordingly, the inductor-leg pair may be referred to as a “power conversion circuit”.

However, when a failure occurs in the FDC 120, for example, when the top switching element, that is, the first switching element S11, is in a short failure state all the time regardless of PWM control due to damage to the first switching element S11, the high-voltage side voltage V_HS corresponding to the voltage of the high-voltage battery 130 is applied to the low-voltage side in accordance with turning on the relays R+ and R−. Accordingly, the electrical equipment 160 designed to have a withstand voltage corresponding to the normal voltage range of the low-voltage side may be damaged. As a specific example, when the fuel cell 110 is a 400V class and the high-voltage battery 130 is an 800V class, in general, when the withstand voltage of the electrical equipment 160 is 600V, it will be regarded as sufficient. However, although there is a difference depending on an SOC, the normal voltage range of an 800V-class battery generally exceeds 600V, so damage due to a short circuit may occur. In particular, the electrical equipment 160 connected to the low-voltage side may include components essential for driving a vehicle, such as a cooling fan EFAN_ATM of a power train (for example, a transmission) or a cooling fan EPAN_PE of a power electronic system, and when a device necessary for driving stacks in the fuel cell 110 such as a fuel cell balance of plant, FC_BOP, is included in the electrical equipment 160, normal driving of the fuel cell 110 may not be possible.

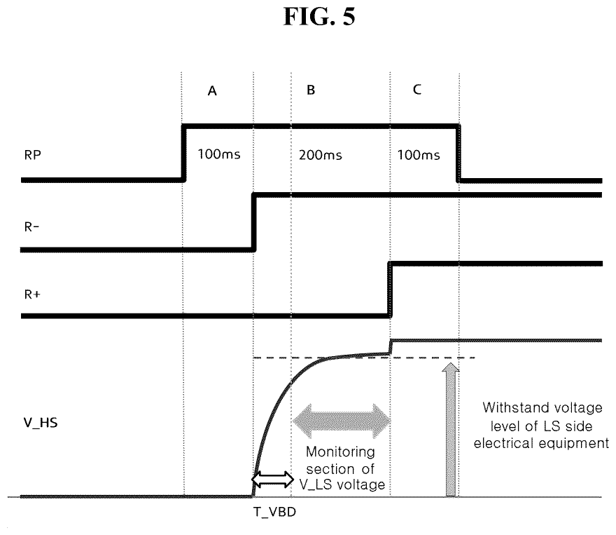

Therefore, in an embodiment of the present description, it is proposed to control the electrical connection state between the high-voltage side voltage of the FDC 120 and the high-voltage battery 130 based on a comparison result between the high-voltage side voltage V_HS and the low-voltage side voltage V_LS. Here, when a short circuit failure occurs in the FDC 120, in order to prevent the voltage of the high-voltage battery 130 from being applied to the low-voltage side as it is, during a section in which the high-voltage side voltage V_HS initially rises, a comparison of the high-voltage side voltage V_HS with the low-voltage side voltage V_LS may be performed. In one implementation, the section in which the high-voltage side voltage V_HS initially rises may be an initial charging section of the high-voltage side capacitor 122 using the pre-charge relay RP. This will be described with reference to FIG. 5.

FIG. 5 shows graphs illustrating a form of performing fault diagnosis of the DC-DC converter in an initial charging procedure according to the embodiment of the present description.

In four graphs shown in FIG. 5, the vertical axis represents the ON/OFF state of each of the relays, RP, R−, and R+, and the high-voltage side voltage V_HS, in order in a direction from top to bottom, and the horizontal axis is shared by each of the graphs and represents time. Here, the high-voltage side voltage V_HS may mean a voltage between opposite ends of the high-voltage side capacitor 122, and it is assumed a situation in which the high-voltage side capacitor 122 is initially completely discharged, so the high-voltage side voltage V_HS is zero.

First, the pre-charging, that is, an initial charging process of the high-voltage side capacitor 122 using the pre-charge relay RP will be described.

With reference to FIG. 5, the BMS 230 may control the pre-charge relay RP to be turned on in section A according to the satisfaction of a preset condition, for example, startup progress IG ON. Thereafter, in section B, the BMS 230 may control the negative electrode relay R− to be in an ON state. Accordingly, the high-voltage battery 130 is electrically connected to opposite ends of the high-voltage side, and as the initial charging of the high-voltage side capacitor 122 starts, the high-voltage side voltage V_HS increases. When the high-voltage side voltage V_HS reaches no less than a predetermined level (for example, 93%) compared with the voltage of the high-voltage battery 130, In section C, as the BMS 230 controls the positive electrode relay R+ to be in an ON state and the pre-charge relay RP to be in an OFF state, the pre-charging procedure is completed.

In the above process, the low-voltage side voltage V_LS in a monitoring section set in the section B where the high-voltage side voltage V_HS rises is monitored. When the low-voltage side voltage V_LS approaches the high-voltage side voltage V_HS, the BMS 230 controls the relays (RP and R−) to be in the off state, so that the high-voltage battery 130 is separated from the circuit. Accordingly, damage to the electrical equipment 160 connected to the low-voltage side may be prevented.

The monitoring section may be set from after the high-voltage battery 130 is electrically connected (that is, both RP and R− are ON) to the high-voltage side until the high-voltage side voltage V_HS reaches the withstand voltage of the electrical equipment 160 connected to the low-voltage side. However, a phenomenon in which the low-side voltage V_LS temporarily rises may initially occur depending on the circuit configuration during the section B. When it is determined whether or not the low-voltage side voltage V_LS is close to the high-voltage side voltage V_HS at a moment when the voltage V_LS temporarily rises, even though increase of the low-voltage side voltage V_LS is not due to a short circuit in fact, there is a possibility that the high-voltage battery 130 may be disconnected from the circuit due to an erroneously determined short circuit determination. Accordingly, an initial section of a predetermined time T_VBD of the section B in which the high-voltage side voltage V_HS rises may be excluded from the monitoring section. In other words, the monitoring section may be started after the predetermined time T_VBD elapses after the opposite ends of the high-voltage battery 130 are connected to the opposite ends of the high-voltage side, respectively, whereby the high-voltage side voltage V_HS starts to rise. Here, the predetermined time T_VBD may be preset in consideration of a temporary rising section of the low-voltage side voltage V_LS according to the internal configuration of the FDC 120, but this is exemplary and is not necessarily limited hereto.

In addition, whether the low-voltage side voltage V_LS is close to the high-voltage side voltage V_HS, that is, whether the high-voltage battery 130 is separated from the circuit may be determined according to whether the low-voltage side voltage V_LS is no less than a value obtained by subtracting a preset margin voltage a from the high-voltage side voltage V_HS. For example, when the low-voltage side voltage V_LS is no less than the value obtained by subtracting the preset margin voltage a from the high-voltage side voltage V_HS, the battery controller 230 may control the relays RP and R− to be in the OFF state. In addition, the margin voltage a may be set in consideration of a voltage measurement error and a voltage drop when a switching element in the FDC 120 is short-circuited, but this is exemplary and is not necessarily limited hereto.

In an implementation, whether to separate the high-voltage battery 130 from the circuit may be determined by the BMS 230 or the converter controller 123.

When it is determined by the BMS 230, the low-voltage side voltage V_LS may, by the BMS, be received from the converter controller 123, and the high-voltage side voltage V_HS is, by the BMS, obtained through measurements and the like of the voltage between the opposite ends of the high-voltage battery 130 or is received from the converter controller 123. When a communication function of the converter controller 123 is difficult to normally operate due to the failure of the FDC 120, the low-voltage side voltage V_LS may be obtained from another controller capable of knowing the low-voltage side voltage V_LS, for example, the fuel cell controller FCU 210 or the fuel cell balance of plant, FC_BOP.

When it is determined by the converter controller 123, the converter controller 123 notifies the BMS 230 of a result (for example, FDC_IGBT_Fail signal) of comparing the low-voltage side voltage V_LS with a value obtained by subtracting the preset margin voltage a from the high-voltage side voltage V_HS and may control the state of each of the relays according to the result received thereby. However, in this case, the converter controller 123 needs information about when the monitoring section starts. To this end, the BMS 230 may provide the converter controller 123 with information on whether the negative electrode relay R− is turned on or not or a scheduled ON time.

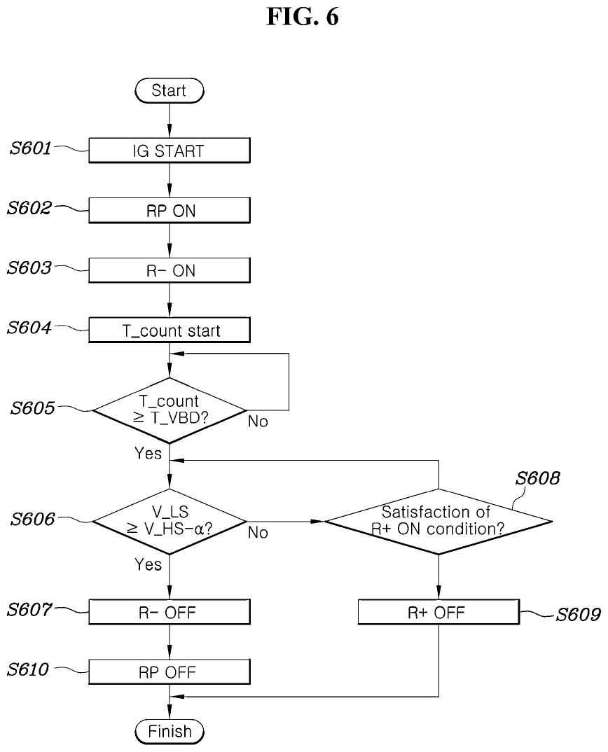

A flowchart of the control process according to the embodiment described so far is organized as shown in FIG. 6.

FIG. 6 is a flowchart illustrating an example of a control process of a fuel cell electric vehicle according to the embodiment of the present description. In FIG. 6, it is assumed that the relay control (that is, whether the high-voltage battery is to be connected to the circuit) through the comparison of the high-voltage side voltage and the low-voltage side voltage is performed by the BMS 230.

With reference to FIG. 6, according to the startup progress in S601, the BMS 230 may control the pre-charge relay RP and the negative electrode relay R− to be sequentially turned on in S602 and S603. Accordingly, the initial charging of the high-voltage side capacitor 122 is started and the voltage of the high-voltage side capacitor 122 starts to rise.

In addition, the BMS 230 activates a counter T_count in S604 as the initial charging is started and waits in S605 until the counter reaches the preset time T_VBD, that is, until the start of the monitoring section.

When the monitoring section starts (Yes in S605), the BMS 230 determines whether the low-voltage side voltage V_LS is no less than the value obtained by subtracting the preset margin voltage a from the high-voltage side voltage V_HS in S606, and when determined to be not (No in S606), it may be determined whether an ON condition of the positive electrode relay R+ is satisfied in S608. The ON condition of the positive electrode relay R+ may be satisfied when the high-voltage side voltage V_HS is a predetermined ratio to the voltage of the high-voltage battery 130. In other words, the BMS 230 may monitor the low-voltage side voltage V_LS after the monitoring section starts until the ON condition of the positive electrode relay R+ is satisfied.

When, within the monitoring section, the low-voltage side voltage V_LS becomes no less than the value obtained by subtracting the preset margin voltage a from the high-voltage side voltage V_HS (Yes in S606), the BMS 230 may control the negative relay R− and the pre-charging relay RP to be in off states in S607 and S610, respectively.

On the other hand, when the ON condition of the positive electrode relay R+ is satisfied (Yes in S608) during the low-voltage side voltage V_LS is being maintained to be no greater than the value obtained by subtracting the preset margin voltage a from the high-voltage side voltage V_HS, the battery controller 230 may control the positive electrode relay R+ to be in an ON state in S609 and control the pre-charging relay RP to be in an OFF state in S610.

Differently from one assumed above for FIG. 6, when the converter controller 123 determines whether the low-voltage side voltage V_LS is no less than the value obtained by subtracting the preset margin voltage a from the high-voltage side voltage V_HS, the counter T_count may be managed by the converter controller 123. In addition, in such a case, for the startup of the counter T_count, the BMS 230 may provide the converter controller 123 with information on whether the negative electrode relay R− is turned on or not or ON time as described above.

Therefore, according to the embodiments of the present description, the connection state of the high-voltage battery and the high-voltage side is controlled based on the low-voltage side capacitor voltage measured in the initial charging period/section of the high-voltage side capacitor of the DC-DC converter. Accordingly, even when a short circuit failure occurs in the DC-DC converter, it is possible to protect the electrical equipment connected to the low-voltage side.

In particular, it is possible to protect the electrical equipment connected to the low-voltage side without increasing the withstand voltage of the electrical equipment connected to the low-voltage side or configuring the DC-DC converter as an insulated type. On the other hand, the present description described above may be implemented as computer-readable codes on a medium in which a program is recorded. The computer-readable medium includes all kinds of recording devices in which data readable by a computer system is stored. Examples of computer-readable media include a Hard Disk Drive (HDD), a Solid State Disk (SSD), a Silicon Disk Drive (SDD), ROM, RAM, CD-ROM, magnetic tape, floppy disk, an optical data storage device, and the like. Accordingly, the detailed description above should not be construed as restrictive in all respects but as exemplary. The scope of the present description should be determined by a reasonable interpretation of the appended claims, and all modifications within the equivalent scope of the present description are included in the scope of the present description.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. A DC-DC converter comprising:
a first capacitor connected to a first DC end;
a second capacitor connected to a second DC end;
a power conversion circuit connected between the first capacitor and the second capacitor, the power conversion circuit including at least one switching element; and
a controller configured to determine, when the second capacitor is charged as a battery is connected to the second DC end, whether the at least one switching element has failed based on a first voltage that is a voltage between opposite ends of the first capacitor and a second voltage that is a voltage between opposite ends of the second capacitor.

2. The DC-DC converter of claim 1, wherein the power conversion circuit comprises:
an inductor having one end connected to a positive (+) terminal of the first DC end; and
a leg having one end connected to a positive (+) terminal of the second DC end and an opposite end connected to a negative (−) terminal of the second DC end;
wherein the leg includes two switching elements connected in series with each other; and
wherein an opposite end of the inductor is connected to a connection node of each of the two switching elements.

3. The DC-DC converter of claim 2, wherein, based on the first voltage and the second voltage, the controller is configured to determine whether a top switching element having one end connected to the positive (+) terminal of the second DC end has failed in a short circuit, out of the two switching elements.

4. The DC-DC converter of claim 1, wherein the controller is configured to determine whether the at least one switching element has failed after a preset time has elapsed after the battery was connected to the second DC end.

5. The DC-DC converter of claim 4, wherein the controller is configured to receive a signal regarding whether the battery is connected to the second DC end from a battery management system that controls the battery.

6. The DC-DC converter of claim 1, wherein the controller is configured to determine whether the at least one switching element has failed when the second capacitor is initially charged while the battery is connected to the second DC end through a pre-charge relay.

7. The DC-DC converter of claim 1, wherein the controller is configured to determine that the at least one switching element has failed when the first voltage is no less than a value obtained by subtracting a preset margin voltage from the second voltage.

8. A vehicle comprising:
a DC-DC converter having a first DC end and a second DC end;
a high-voltage battery connected to the second DC end through a plurality of switches; and
a controller configured to manage the high-voltage battery and to control states of the plurality of switches;
wherein the DC-DC converter includes:
a first capacitor connected to the first DC end;
a second capacitor connected to the second DC end; and
a power conversion circuit connected between the first capacitor and the second capacitor, the power conversion circuit including at least one switching element; and
wherein the controller is configured, when the second capacitor is charged as the battery is connected to the second DC end, to control the states of the plurality of switches based on a first voltage that is a voltage between opposite ends of the first capacitor and a second voltage that is a voltage between opposite ends of the second capacitor.

9. The vehicle of claim 8, wherein the power conversion circuit comprises:
an inductor having one end connected to a positive (+) terminal of the first DC end; and
a leg having one end connected to a positive (+) terminal of the second DC end and an opposite end connected to a negative (−) terminal of the second DC end;
wherein the leg includes two switching elements connected in series with each other; and
an opposite end of the inductor is connected to a connection node of each of the two switching elements.

10. The vehicle of claim 8, wherein the controller is configured to compare the first voltage with the second voltage after a preset time has elapsed after the high-voltage battery was connected to the second DC end.

11. The vehicle of claim 10, wherein the controller is configured to control the states of the plurality of switches such that the high-voltage battery is disconnected from the second DC terminal when the first voltage is no less than a value obtained by subtracting a preset margin voltage from the second voltage.

12. The vehicle of claim 10, wherein the plurality of switches comprises:
a first relay connected to one end of the battery;
a second relay connected to an opposite end of the battery; and
a third relay connected in parallel with the first relay to one end of the battery and connected in series with a pre-charge resistor.

13. The vehicle of claim 12, wherein the controller is configured to control the third relay to be in an ON state and the second relay to be in an ON state, thereby comparing the first voltage and the second voltage after the preset time has elapsed from the time when the initial charging of the second capacitor started.

14. The vehicle of claim 12, wherein the controller is configured to control the third relay to be in the ON state, and the second relay to be in the ON state, and then to compare the first voltage and the second voltage until controlling the first relay to be in an ON state according to satisfaction of a preset condition.

15. The vehicle of claim 8, wherein the controller is configured to obtain information on the first voltage from the DC-DC converter or electrical equipment connected to the first DC end.

16. The vehicle of claim 8, further comprising:
a fuel cell connected to the first DC end.
